(19) United States
(12) Patent Application Publication
(10) Pub. No.: US 2003/0154376 A1
(43) Pub. Date: Aug. 14, 2003

(54) Optical storage medium for storing, a public key infrastructure (pki)-based private key and certificate, a method and system for issuing the same and a method for using

(76) Inventor: Yeoul Hwangbo, Seoul (KR)

Correspondence Address: HOVEY WILLIAMS TIMMONS & COLLINS, 2405 GRAND BLVD., SUITE 400, KANSAS CITY, MO, 64108

(21) Appl. No.: 10/240,958

(22) PCT Filed: Feb. 16, 2001
(86) PCT No.: PCT/KR01/00234

(30) Foreign Application Priority Data
Feb. 5, 2001 (KR) 2001/5478

(51) Int. Cl. H04L 9/00

(52) U.S. Cl. 713/173; 380/277

(57) ABSTRACT

This invention concerns an optical storage medium which stores a public key infrastructure(PKI)-based private key and a digital certificate for certificate for certification and security used in electronic commerce, and a method and system for issuing the private key and digital certificate, as well as a method of using such an optical storage medium and system. The optical storage medium, such as a compact disk or digital video disk, provides for a digital signature and may be used in conjunction with a memorized password by the user. By providing an optical storage medium capable of storing large amounts of data, the user can employ the private key and digital certificate even though he or she is not familiar with a computer.

### TECHNICAL FIELD

The present invention relates in general to an optical storage medium for storing a public key infrastructure (PKI)-based private key and digital certificate for certification and security in electronic commerce, a method and system for issuing the same and a method for using such, and more particularly to an optical storage medium for storing a PKI-based private key and digital certificate, a method and system for issuing the same and a method for using such, wherein, on the basis of characteristics of the optical storage medium, such as a compact disk (CD) or digital video disk (DVD), a digital signature is performed for certification, detection of message forgery or alteration, and prevention of transaction negation, and the PKI-based private key and digital certificate are conveniently applied for and issued for message encryption and communication security and are stored in the optical storage medium with improvements in utilization and security.

### BACKGROUND ART

Recently, with the development of communication networks such as the Internet, electronic commerce over them has rapidly increased in number and more various business processes have been conducted over them. However, these communication networks such as the Internet generally make insufficient provision for security and are thus subject to many risks. For example, in terms of electronic transaction service providers, such as banks, security corporations, shopping mall companies, government and public offices, etc., there is a danger for a person to disguise himself or herself as an electronic transaction service provider to illegally abuse customer information. On the contrary, in terms of service users, there is a danger for a person to hack important information of each user, such as an identification (ID), credit card number, account number, password, etc., during their transfer. Provided that such a person forges or alters the hacked user information, an associated service user will be subject to severe losses/inconveniences. As a result, tight security must be maintained between electronic transaction service providers and service users so that they can safely and reliably process electronic transaction operations related to each other. In this regard, certification and security techniques have become more important.

A variety of studies have actively been made in order to meet a need for such certification and security techniques. Some companies, universities and research institutes have developed such certification and security techniques and put them to practical use.

First, considering the use of an ID and password, an associated user can skillfully and conveniently use the ID and password, but there is a danger of information leakage when sending them as they are. The ID and password may be encrypted and then sent, in order to overcome such danger. However, the encrypted ID and password are not safe in security-based electronic commerce in that they depend on the user's memory and are encrypted in a simple manner. Besides this encryption, there have been proposed certification and security methods using physical media, fingerprints, writing styles, etc. But, these certification and security methods provide nothing but simple certifications and limited securities, that is, do not provide full certifications and securities for electronic commerce.

For these reasons, a public key infrastructure has been proposed as a standard for allowing a reliable certification authority to authenticate a user's identity and issue a public key certificate to the user and allowing the user to perform a digital signature and encryption using his or her private key preserved in safety and the public key certificate issued from the certification authority, thereby certainly ensuring certification, integrity, confidentiality and repudiation prevention.

In the public key infrastructure, in order to perform a digital signature and encryption using a private key and public key certificate, it is necessary for the user to apply to a certification authority for the digital certificate and receive the certificate issued from the certification authority. However, the user has a difficulty in applying for the digital certificate, receiving the issued certificate and using it with the private key being currently used, because the procedures are complex and are performed separately from one another. Accordingly, the results of certificate use and in turn the spread thereof become poor.

FIG. 1 is a drawing illustrating conventional digital certificate application and issuance procedures.

First, a user visits a registration authority (RA) and applies thereto for a digital certificate (step 1).

Then, the registration authority authenticates the user's identity (step 2), and issues a token to the user and provides the issued token to the user under the condition that it is stored in a smart card or diskette or it is printed or copied on paper (step 3). This token, transferred offline to the user, includes information such as an ID and password of the user or their encrypted codes, with which the user creates his or her key pair, or a public key and private key, and requests the issuance of the digital certificate.

The user downloads a digital certificate management program from a server of a certification authority (CA) and installs it in his or her terminal located in an office or home for use of the digital certificate (step 4). The user then creates the public key and private key according to the certificate management program (step 5).

The user sends a digital certificate request message PKCS#10 containing the token issued from the registration authority and his or her public key to the certification authority server to request it to issue the digital certificate (step 6). The certification authority server verifies the validity of the certificate request message sent from the user (step 7) and sends a certificate request response message to the user, that is, issues the digital certificate to the user. The certification authority server then stores the issued digital certificate in a digital certificate depository (X.500 directory or LDAP server) (step 8) and meanwhile sends it to the user (step 9).

The user downloads the digital certificate from the certification authority server and preserves it in a storage medium, such as a hard disk, diskette, integrated circuit (IC) card, smart card or the like, together with the public key and private key to utilize them for his or her digital signature, message encryption and communication security afterwards (step 10).

However, the above-mentioned conventional method comprises a plurality of different steps carried out separately from one another, namely, the first to third steps of, by the registration authority, authenticating the user's identity and, by the user, downloading information necessary to access to the certification authority server from the registration authority, the fourth step of, by the user, online installing the digital certificate management program in his or her terminal, the fifth step of, by the user, creating the private key and public key pair, and the sixth, ninth and tenth steps of, by the user, receiving the digital certificate issued from the certification authority server. For this reason, provided that the user is not skilled with a computer, digital signature or encryption, he or she will feel frustrated and hesitate to use the digital certificate.

In addition, there are some problems with a hard disk, floppy disk, smart card and IC card recommended generally as media for storage of the public key infrastructure-based private key and digital certificate. For storage of the certificate information in the hard disk, the stored certificate information is in danger from hacking and is limited in mobility due to its use in only a fixed location. For storage of the certificate information in the floppy disk, the stored certificate information is in danger of duplication and is difficult to preserve for a lengthy period of time because the floppy disk is small in capacity and easily damaged. For storage of the certificate information in the smart card or IC card, there is a need for an additional device (smart card or IC card reader), which has been developed at a great cost and not generalized yet. This device has also not been standardized due to independent developments of associated companies, resulting in a reduction in compatibility among various products.

### DISCLOSURE OF THE INVENTION

Therefore, the present invention has been made in view of the above problems, and it is an object of the present invention to provide an optical storage medium for storing a public key infrastructure-based private key and digital certificate, which is capable of facilitating issuance and use of the private key and digital certificate.

It is another object of the present invention to provide a method for issuing an optical storage medium having a public key infrastructure-based private key and digital certificate stored therein, wherein a user can be conveniently issued with the private key and digital certificate even though he or she is not skilled with a computer.

It is a further object of the present invention to provide a system for issuing an optical storage medium having a public key infrastructure-based private key and digital certificate stored therein, wherein the private key and digital certificate can be improved in utilization and security.

It is yet another object of the present invention to provide a method for using an optical storage medium having a public key infrastructure-based private key and digital certificate stored therein, which is capable of facilitating issuance and use of the private key and digital certificate and improving the utilization and security of the private key and digital certificate in use.

In a main feature of the present invention, there are provided an optical storage medium for storing a public key infrastructure (PKI)-based private key and digital certificate, a method and system for issuing the same and a method for using such, wherein a registration authority (RA), to which a user applies for a digital certificate, authenticates the user's identity, registers user information, creates a pair of keys, or a private key and a public key, issues the certificate and stores the created private key and the issued certificate in the optical storage medium, such as a CD or DVD, together with associated software modules, thereby enabling the certificate application and issuance to be processed in a single place, and the user performs a digital signature with the optical storage medium having the private key and digital certificate stored therein so that the digital signature can be applied to all processes associated with user authentication and message security.

The optical storage medium has such a very large data storage capacity as to store together a certificate management program, an automatic access program, PKI-based application programs, public relation contents and so forth. This large-capacity data storage capability of the optical storage medium enables the user to conveniently use the private key and digital certificate, and increases the portability of the storage medium by the user. As a result, the user can use the private key and digital certificate in any place irrespective of a specific computer or terminal.

In accordance with one aspect of the present invention, the optical storage medium is adapted to store a PKI-based user certificate, the user certificate being issued from a certification authority and including a public key for verification of a digital signature; at least one certification authority certificate including a public key for verification of the user certificate; and a user private key for the digital signature, encrypted with a digital signature password memorized by a user on the basis of a password-based encryption standard (PKCS#5).

Preferably, in order to prevent the optical storage medium from being lost and abused, and to strengthen security for the storage medium, the private key may be stored in the medium after being encrypted once more with a password key, the password key being an optical storage medium security key stored and managed in a security key management server.

The user certificate may include an extension field based on a certificate standard (X.509), the extension field including an optical storage medium extension field for storing a unique user registration number for access to user information stored in a user information database server.

Further, the optical storage medium may store a certificate management program for performing a digital signature function based on the user certificate and private key, and user certificate/private key management, discard and reissuance application functions; an installation program for setting up environments for execution of the certificate management program in a computer of the user; an automatic access program for gaining automatic access to a specific Web server such that the user certificate is used in electronic commerce or electronic business processes; a Web/mail plug-in program; PKI-based application programs, the application programs including an electronic purse program; and human body recognition information and public relation contents, the human body recognition information including fingerprints and retina map.

More preferably, a magnetic strip, radio frequency chip or integrated circuit chip may be attached to the optical storage medium so that the medium is applicable offline to a credit card, debit card, prepaid card, membership card and bus card as well as online to a digital signature-based certification.

In accordance with another aspect of the present invention, the method for issuing the optical storage medium having the PKI-based private key and digital certificate stored therein comprises the steps of a), by a registration authority computer, checking a user's identity in response to a digital certificate issuance request from the user, authenticating the user in accordance with the checked result, inputting user information entered by the user, transferring the inputted user information to a user information database server and registering it therein; b), by the registration authority computer, forming a temporary storage area related to the user in its storage unit; c), by the registration authority computer, creating a PKI-based public key and private key pair; d), by the registration authority computer, encrypting the created private key with a digital signature password memorized by the user on the basis of a password-based encryption standard and storing the encrypted private key in the temporary storage area; e), by the registration authority computer, producing a digital certificate request message (PKCS#10) containing the created public key and transferring the produced message to a certification authority server; f), by the registration authority computer, receiving a user certificate issued from the certification authority server and storing the received certificate in the temporary storage area; g), by the registration authority computer, reading the user certificate and private key stored in the temporary storage area and at least one certification authority certificate prestored in the storage unit and writing the read user certificate, private key and certification authority certificate on the optical storage medium; and h), by the registration authority computer, erasing the temporary storage area in the storage unit.

Preferably, the temporary storage area may be a storage area of the storage unit which is erased after temporarily storing the user private key and certificate to write them on the optical storage medium through an optical storage medium writer.

The user may apply for the certificate on the Web if his or her identity has already been authenticated.

In order to guarantee the safe creation of the public key and private key pair, the above steps c) and d) may include the step of, by the registration authority computer, performing only the certificate issuance function without directly creating the public key and private key pair, and then sending a registration associated picture and password entry picture respectively to the user such that the user personally creates the key pair and enters the digital signature password.

Preferably, the registration authority computer may register a serial number of the user certificate in the user information database server after receiving the user certificate from the certification authority server at the above step f). Alternatively, the registration authority computer may receive a unique user registration number produced from the user information database server after registering the user information in the user information database server at the above step a). In this case, the registration authority computer may produce the digital certificate request message and append the received unique user registration number to the produced certificate request message, thereby enabling the interoperability between the user certificate and user information database to utilize user information not included in the user certificate.

In order to strengthen security for the private key, the registration authority computer may encrypt the private key with an optical storage medium security key as a password key after receiving the certificate issued from the certification authority server and store the optical storage medium security key in a security key management server.

In accordance with a further aspect of the present invention, the system for issuing the optical storage medium having the PKI-based private key and digital certificate stored therein, is adapted to issue the optical storage medium using a user information database server, a security key management server, a registration authority computer and a certification authority server interconnected via a computer communication network. The system comprises a storage unit, a processing unit connected to the storage unit, and an optical storage medium writer connected to the storage unit and processing unit. The processing unit is interoperable with the control program to input the user information, register it in the user information database server, form a temporary storage area related to a user in the storage unit, create a public key and private key pair for production of a PKI-based digital certificate request message, encrypt the created private key with a digital signature password memorized by the user on the basis of a password-based encryption standard, store the encrypted private key in the temporary storage area, produce the digital certificate request message containing the created public key, transfer the produced message to the certification authority server, receive a user certificate issued from the certification authority server, store the received certificate in the temporary storage area, read the user certificate and private key stored in the temporary storage area and a certification authority certificate prestored in the storage unit, write the read user certificate, private key and certification authority certificate on the optical storage medium and then erase the temporary storage area in the storage unit.

In accordance with yet another aspect of the present invention, the method for using the optical storage medium having the PKI-based private key and digital certificate stored therein, comprises the steps of a) gaining access to a Web server requiring a user certification and security, using a computer equipped with an optical storage medium reader; b) receiving a digital signature request message from the Web server; c) running a certificate management program in the computer; d) inserting the optical storage medium into the optical storage medium reader if the medium has not been yet inserted into the reader; e) transferring a user certificate received from the Web server; and f) performing a digital signature with a digital signature password from a user and sending the digital signature to the Web server.

Preferably, the user certificate may include a basic field and extension field based on a certificate standard (X.509).

As an alternative, the optical storage medium using method may employ a security key management server. In this case, unless an optical storage medium security key is not present in a storage unit of the computer after the certificate management program is run, the computer downloads the security key from the security key management server, stores the downloaded security key in the storage unit, decrypts the encrypted private key with the stored security key and performs the digital signature with the decrypted private key.

In case the user owning the optical storage medium having the PKI-based private key and digital certificate stored therein selects a payment system based on a mobile telecommunication company to purchase a commodity or service from a shopping mall, the certification procedure based on the digital signature is performed with the optical storage medium according to the above-stated optical storage medium using method. Thereafter, a certification server requests the mobile telecommunication company to check whether a mobile telephone number presented by the user is the user's one, determines that the transaction by the user is allowable if the presented mobile telephone number is the user's one, and then sends a message indicative of the allowable transaction to the shopping mall, thereby enabling the user to settle his or her account for the purchasing price with the shopping mall.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a drawing illustrating conventional digital certificate application and issuance procedures;

FIG. 2 is a block diagram showing the construction of a system for issuing an optical storage medium having a public key infrastructure-based private key and digital certificate stored therein in accordance with the present invention;

FIG. 3 is a flowchart illustrating a method for issuing an optical storage medium having a public key infrastructure-based private key and digital certificate stored therein in accordance with a first embodiment of the present invention;

FIG. 4 is a flowchart illustrating a method for issuing an optical storage medium having a public key infrastructure-based private key and digital certificate stored therein, using a security key management server, in accordance with a second embodiment of the present invention;

FIG. 5 is a flowchart illustrating a method for issuing an optical storage medium having a public key infrastructure-based private key and digital certificate stored therein, using an optical storage medium label output unit, in accordance with a third embodiment of the present invention;

FIG. 6 is a flowchart illustrating a method for issuing an optical storage medium having a public key infrastructure-based private key and digital certificate stored therein, using a unique number of user registration in a user information database, in accordance with a fourth embodiment of the present invention;

FIG. 7 is a flowchart illustrating a method for issuing an optical storage medium having a public key infrastructure-based private key and digital certificate stored therein, using a serial number of the digital certificate issued from a certification authority, in accordance with a fifth embodiment of the present invention;

FIG. 8 is a view illustrating the contents stored in a storage unit of a computer of a registration authority in accordance with the present invention;

FIG. 9 is a view illustrating the contents stored in an optical storage medium in accordance with the present invention;

FIG. 10 is a view illustrating the format of a user certificate stored in the optical storage medium in accordance with the present invention;

FIG. 11 is a flowchart illustrating a method for using the optical storage medium having the public key infrastructure-based private key and digital certificate stored therein in accordance with the first embodiment of the present invention;

FIGS. 12a to 12c are flowcharts illustrating a method for using the optical storage medium having the public key infrastructure-based private key and digital certificate stored therein, using the security key management server, in accordance with the second embodiment of the present invention; and

FIG. 13 is a drawing illustrating a procedure of payment through a mobile telecommunication company by a user using the optical storage medium having the public key infrastructure-based private key and digital certificate stored therein in accordance with the present invention.

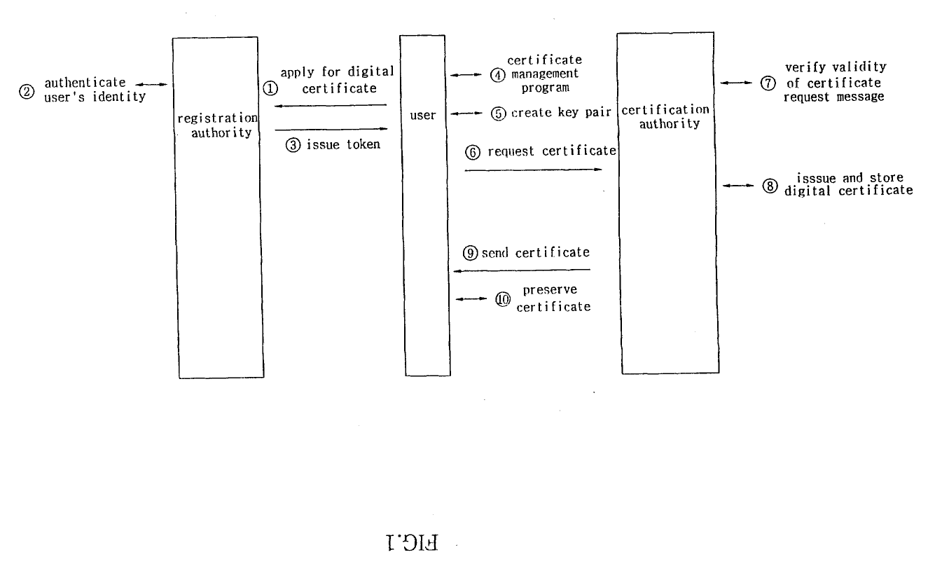

### BEST MODE FOR CARRYING OUT THE INVENTION

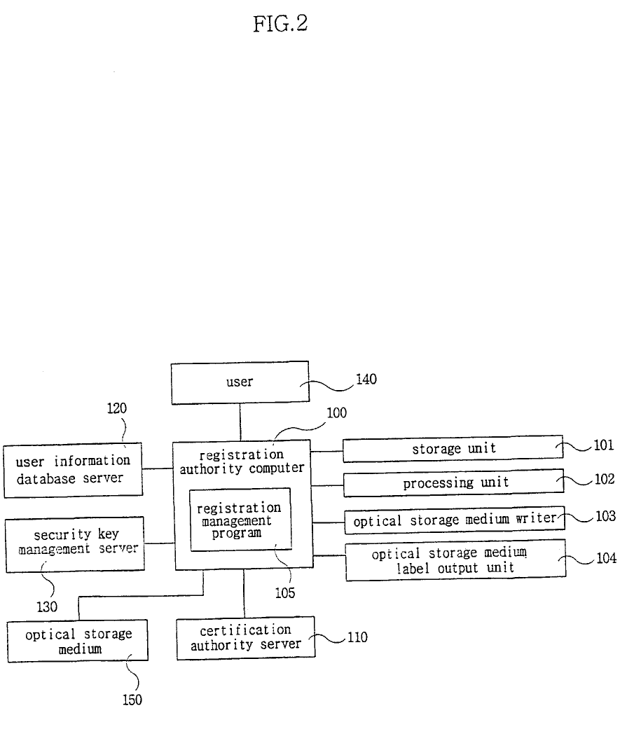

With reference to FIG. 2, there is schematically shown in block form the construction of a system for issuing an optical storage medium having a public key infrastructure (PKI)-based private key and digital certificate stored therein in accordance with the present invention.

As shown in FIG. 2, the optical storage medium issuance system of the present invention basically comprises a computer 100 of a registration authority, a server 110 of a certification authority for creating a PKI-based user certificate by attaching a digital signature to the user certificate using its private key, a user information database server 120 for storing user information, and a security key management server 130.

A user 140 must visit the registration authority and apply thereto for a digital certificate.

Provided that the user's identity has already been authenticated, the user will be able to apply for the digital certificate on the Web or over the telephone with no necessity for visiting the registration authority.

In response to the user's application for the digital certificate, the registration authority computer 100 issues the certificate to the user while communicating with the certification authority server 110 and user information database server 120 over an Internet network, not shown. The registration authority computer 100 then writes the issued digital certificate on an optical storage medium 150, such as a CD, and issues the resulting medium 150 to the user.

That is, the registration authority computer 100 is adapted to issue the optical storage medium 150 having the PKI-based user certificate and private key stored therein over the communication network. To this end, the registration authority computer 100 includes a storage unit 101 for storing a program for control of a processing unit 102 and an internal system operation and information regarding the operation.

The processing unit 102 is connected to the storage unit 101 to operate according to the control program stored therein.

The registration authority computer 100 further includes an optical storage medium writer 103 connected to the storage unit 101 and processing unit 102.

The processing unit 102 is interoperable with the control program to input user information, register it in the user information database server 120, form a temporary storage area related to the user in the storage unit 101 and create a public key and private key pair for production of a PKI-based digital certificate request message PKCS#10. The processing unit 102 also encrypts the created private key with a digital signature password memorized by the user on the basis of a password-based encryption standard PKCS#5, and stores the encrypted private key in the temporary storage area. The unit 102 then produces the digital certificate request message containing the created public key, transfers the produced message to the certification authority server 110, receives a user certificate issued from the server 110 and stores the received certificate in the temporary storage area. It further reads the user certificate and private key stored in the temporary storage area and a certification authority certificate prestored in the storage unit 101, writes the read contents on the optical storage medium 150 and then erases the temporary storage area in the storage unit 101.

The registration authority computer 100 further includes an optical storage medium label output unit 104 in addition to the storage unit 101, processing unit 102 and optical storage medium writer 103. The computer 100 also contains a registration management program 105 for processing a certificate issuance procedure.

The security key management server 130 is adapted to manage an optical storage medium security key for access to the user private key stored in the optical storage medium 150.

Preferably, the processing unit 102 may encrypt the private key encrypted with the digital signature password, once more with the optical storage medium security key as a password key, before storing it in the temporary storage area. In this case, the processing unit 102 stores the once more encrypted private key in the temporary storage area and transfers the optical storage medium security key to the security key management server 130, which in turn stores it.

Further, the processing unit 102 may receive a unique user registration number from the user information database server 120 after registering the user information therein.

In order to insert the unique user registration number from the user information database server 120 into an extension field of the user certificate, the processing unit 102 appends the unique user registration number to the produced certificate request message and transfers the resulting certificate request message to the certification authority server 110.

Further, the processing unit 102 may register a serial number of the user certificate in the user information database server 120 after receiving the user certificate from the certification authority server 110 and storing it in the temporary storage area.

The optical storage medium label output unit 104 is adapted to output a label to be attached to the optical storage medium 150, after the registration authority computer 100 writes the user certificate and private key on the medium 150. The label may preferably contain the user's name, unique number, barcode, colorPIMS, etc.

In addition to the private key and digital certificate, the registration authority computer 100 writes on the optical storage medium 150 through the optical storage medium writer 103 a plurality of programs, or a certificate management program for performing a digital signature function based on the user certificate and private key, and user certificate/private key management, discard and reissuance application functions, an installation program for setting up environments for execution of the certificate management program in a computer of the user, an automatic access program for gaining automatic access to a specific Web server such that the user certificate is used in electronic commerce or electronic business processes, a Web/mail plug-in program, and other PKI-based application programs such as an electronic purse program. Besides these programs, the registration authority computer 100 also writes human body recognition information, such as fingerprints, retina map and the like, and public relation contents on the optical storage medium 150. As a result, the optical storage medium 150 can be utilized in various ways.

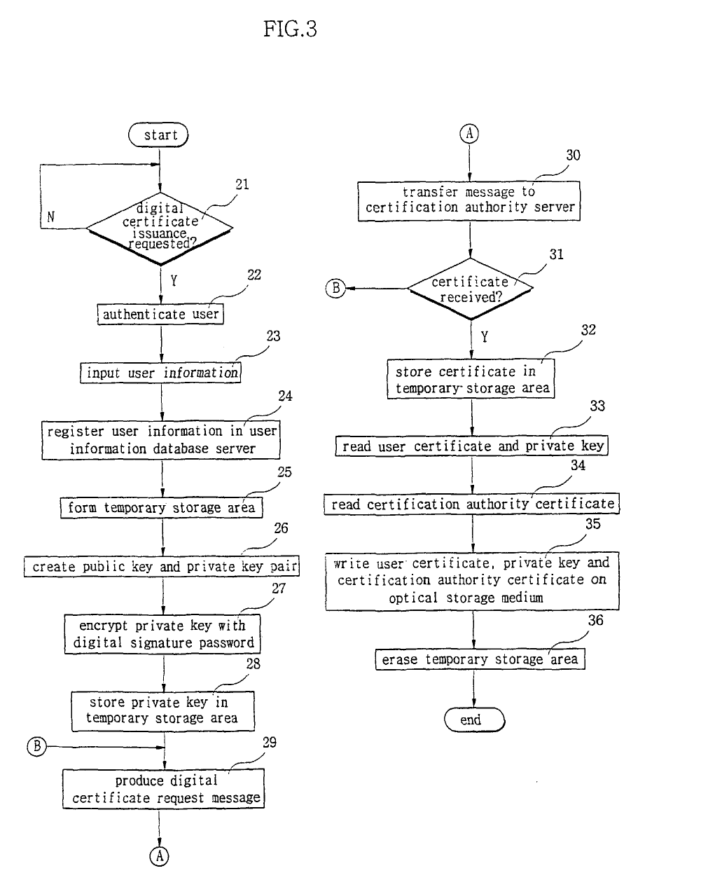

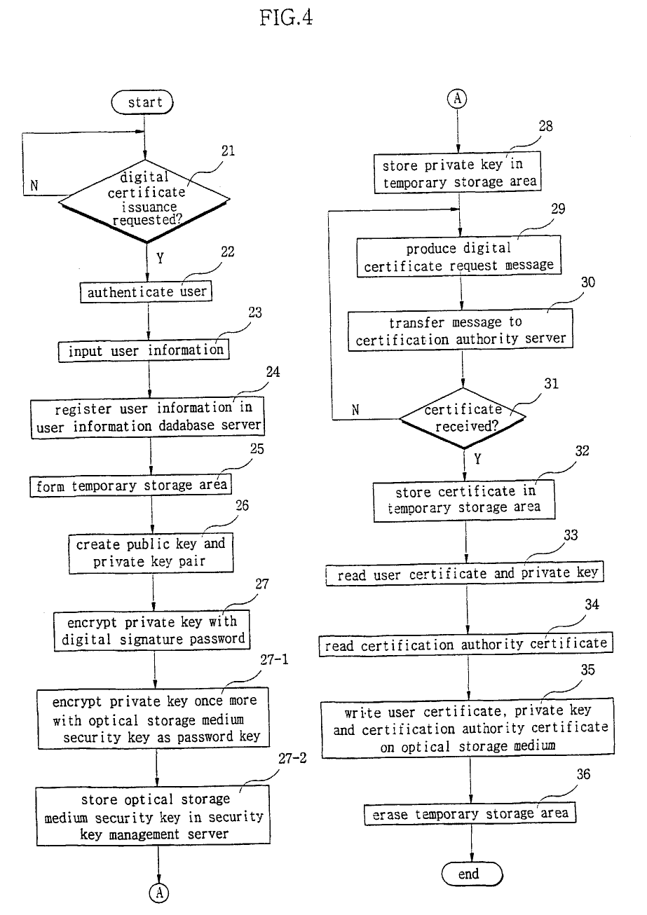

FIG. 3 is a flowchart illustrating a method for issuing an optical storage medium having a PKI-based private key and digital certificate stored therein, using the optical storage medium issuance system with the above-stated construction, in accordance with a first embodiment of the present invention.

The registration authority computer 100 is adapted to issue an optical storage medium 150 having a PKI-based user certificate and private key stored therein, by communicating with the user information database server 120, which stores user information, and the certification authority server 110, which creates the PKI-based user certificate by attaching a digital signature to the user certificate using its private key, over a computer communication network, as will hereinafter be described in detail.

First, if the user requests the registration authority to issue a digital certificate (step 21), then the registration authority computer 100 inquires about the user's identity and authenticates the user in accordance with the inquired result (step 22). The registration authority computer 100 then notifies the user of user information items to be entered, and inputs correct user information entered by the user (step 23). Subsequently, the computer 100 transfers the inputted user information to the user information database server 120 and registers it therein (step 24).

The registration authority computer 100 forms a temporary storage area related to the user in the storage unit 101 (step 25) and creates a public key and private key pair for a PKI-based digital signature and encryption (step 26).

The computer 100 encrypts the created private key with a digital signature password memorized by the user on the basis of the password-based encryption standard PKCS#5 (step 27), and stores the encrypted private key in the temporary storage area (step 28).

The computer 100 then produces a digital certificate request message containing the created public key (step 29) and transfers the produced message to the certification authority server 110 (step 30).

Subsequently, if the registration authority computer 100 receives a user certificate issued from the certification authority server 110 (step 31), then it stores the received certificate in the temporary storage area of the storage unit 101 (step 32).

The registration authority computer 100 reads the user certificate and the private key encrypted with the user's digital signature password on the basis of the password-based encryption standard PKCS#5, stored in the temporary storage area (step 33). The computer 100 also reads at least one certification authority certificate prestored in the storage unit 101 (step 34). The computer 100 then writes the read user certificate, private key and certification authority certificate on the optical storage medium 150 and issues the resulting optical storage medium to the user (step 35).

Thereafter, the registration authority computer 100 erases the temporary storage area in the storage unit 101 (step 36).

On the other hand, at the above steps 26 to 28 of creating the public key and private key pair, encrypting the created private key with the digital signature password and storing the encrypted private key in the temporary storage area of the storage unit 101, the registration authority computer 100 may perform only the certificate issuance function without itself creating the public key and private key pair. In this case, the registration authority computer 100 sends a registration associated picture and password entry picture respectively to the user, thereby allowing the user to personally create the key pair and enter the digital signature password.

FIG. 4 is a flowchart illustrating a method for issuing an optical storage medium having a public key infrastructure-based private key and digital certificate stored therein, using the security key management server 130, in accordance with a second embodiment of the present invention.

The second embodiment of the present invention is the same in operation as the first embodiment, with the exception that the security key management server 130 is further employed to manage an optical storage medium security key for access to the user private key stored in the optical storage medium 150. Namely, the registration authority computer 100 encrypts the private key encrypted with the digital signature password, once more with the optical storage medium security key as a password key, before storing it in the temporary storage area (step 27-1), transfers the optical storage medium security key to the security key management server 130 to store it therein (step 27-2), and then stores the once more encrypted private key in the temporary storage area (step 28).

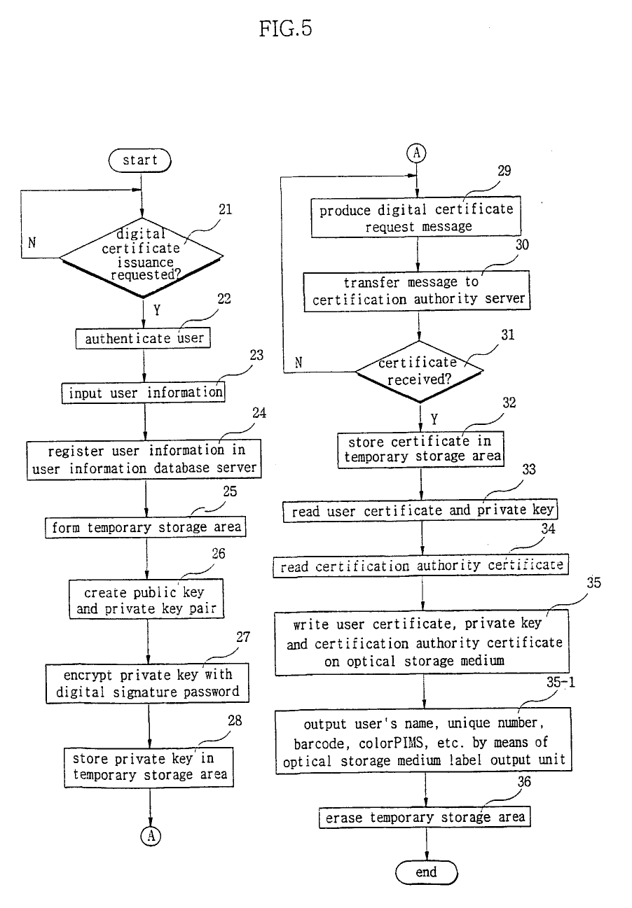

FIG. 5 is a flowchart illustrating a method for issuing an optical storage medium having a public key infrastructure-based private key and digital certificate stored therein, using the optical storage medium label output unit 104, in accordance with a third embodiment of the present invention.

The third embodiment of the present invention is the same in operation as the first embodiment, with the exception that the optical storage medium label output unit 104 is further employed to output a label to be attached to the optical storage medium 150. That is, the registration authority computer 100 writes the user certificate, private key and certification authority certificate on the optical storage medium 150 (step 35), and the optical storage medium label output unit 104 then outputs a label to be attached to the optical storage medium 150 (step 35-1). The label may preferably contain the user's name, unique number, barcode, colorPIMS, etc.

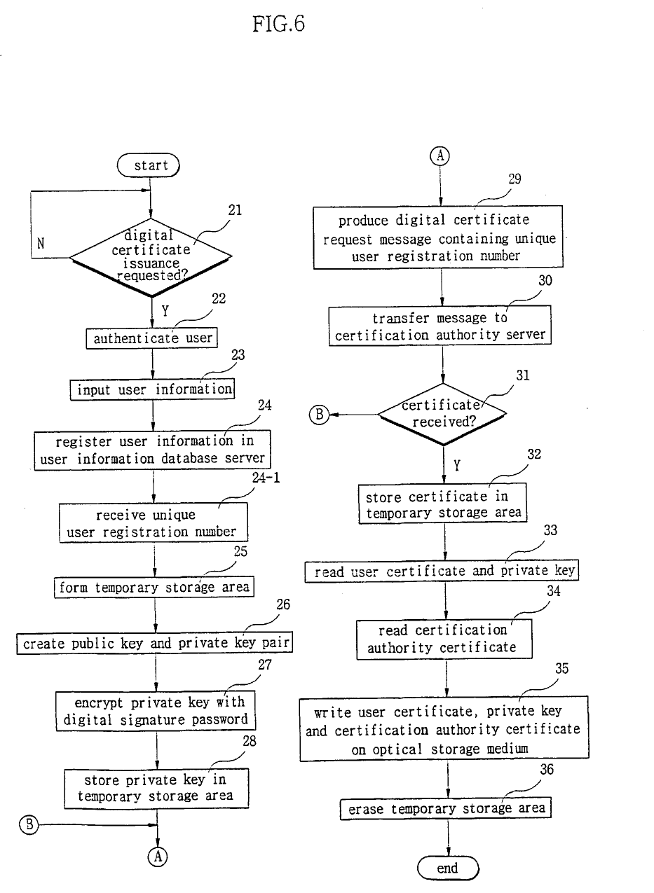

FIG. 6 is a flowchart illustrating a method for issuing an optical storage medium having a public key infrastructure-based private key and digital certificate stored therein, using a unique number of user registration in a user information database, in accordance with a fourth embodiment of the present invention, wherein the certificate is interoperable with the user information database on the basis of the unique user registration number.

In the fourth embodiment, the registration authority computer 100 receives a unique user registration number produced from the user information database server 120 at step 24-1 after registering user information in the server 120 at step 24 in FIG. 3. Then, the registration authority computer 100 produces a digital certificate request message and appends the received unique user registration number to the produced certificate request message at step 29.

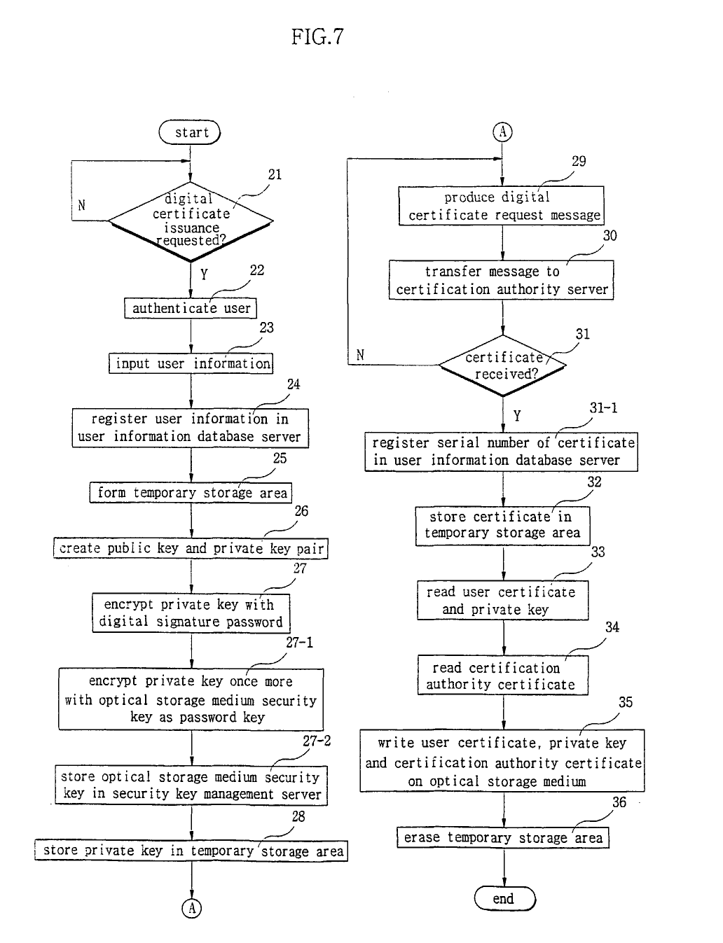

FIG. 7 is a flowchart illustrating a method for issuing an optical storage medium having a public key infrastructure-based private key and digital certificate stored therein, using a serial number of the digital certificate issued from the certification authority, in accordance with a fifth embodiment of the present invention, wherein the certificate is interoperable with the user information database on the basis of the certificate serial number.

In the fifth embodiment, the registration authority computer 100 registers a serial number of a user certificate in the user information database server 120 at step 31-1 after receiving the user certificate from the certification authority server 110 at step 31 in FIG. 3.

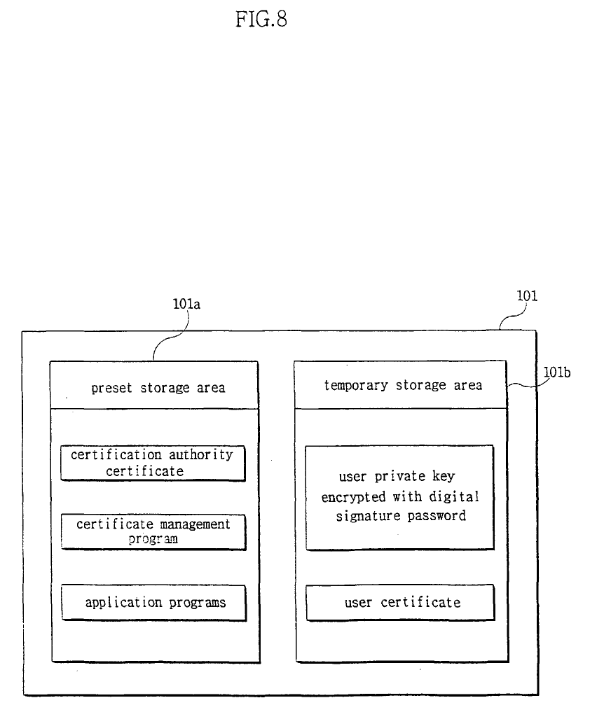

FIG. 8 is a view illustrating the contents stored in the storage unit 101 of the registration authority computer 100 in accordance with the present invention. As shown in this drawing, the storage unit 101 is provided with a preset storage area 101a and temporary storage area 101b.

Selectively stored in the preset storage area 101a are at least one certification authority certificate, a certificate management program for performing a digital signature function based on a private key, and user certificate/private key management, discard and reissuance application functions, an installation program for setting up environments for execution of the certificate management program in a computer of the user, an automatic access program for gaining automatic access to a specific Web server such that the user private key and certificate are used in electronic commerce or electronic business processes, a Web/mail plug-in program, and other PKI-based application programs such as an electronic purse program.

Temporarily stored in the temporary storage area 101b are a user certificate issued from the certification authority and including a public key for verification of a digital signature, and a user private key for the digital signature, encrypted with a digital signature password memorized by the user on the basis of the password-based encryption standard.

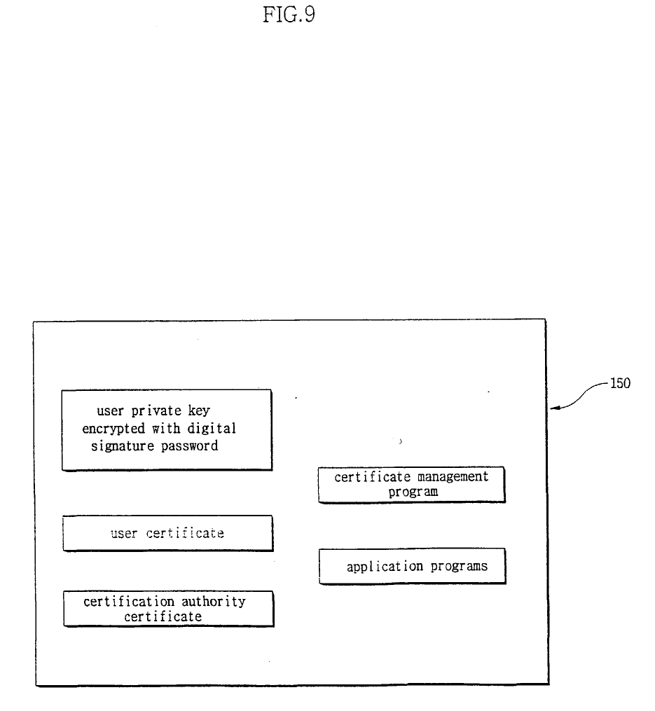

FIG. 9 is a view illustrating the contents stored in the optical storage medium 150 in accordance with the present invention. As stated above, the optical storage medium issuance system and method are adapted to issue the optical storage medium 150 having a PKI-based private key and digital certificate stored therein.

In more detail, the optical storage medium 150 stores, as shown in FIG. 9, a PKI-based user certificate, and at least one certification authority certificate including a public key for verification of the user certificate. The user certificate is issued from the certification authority and includes a public key for verification of a digital signature. The medium 150 further stores a user private key for the digital signature, encrypted with a digital signature password memorized by the user on the basis of the password-based encryption standard.

The private key may preferably be stored in the optical storage medium 150 after being encrypted once more with a password key which is an optical storage medium security key stored and managed in the security key management server 130.

Each of the certification authority certificate, user certificate and user private key stored in the optical storage medium 150 may be one or more in number if necessary.

Further, the optical storage medium 150 selectively stores a certificate management program for performing a digital signature function based on the user certificate and private key, and user certificate/private key management, discard and reissuance application functions, an installation program for setting up environments for execution of the certificate management program in a computer of the user, an automatic access program for gaining automatic access to a specific Web server such that the user certificate is used in electronic commerce or electronic business processes, a Web/mail plug-in program, and other PKI-based application programs such as an electronic purse program.

On the other hand, a magnetic strip, radio frequency (RF) chip or IC chip may be additionally attached to the optical storage medium 150 which stores the PKI-based private key and digital certificate, so that the medium 150 can be applied offline to a credit card, debit card, prepaid card, membership card, bus card or the like as well as online to a digital signature-based certification.

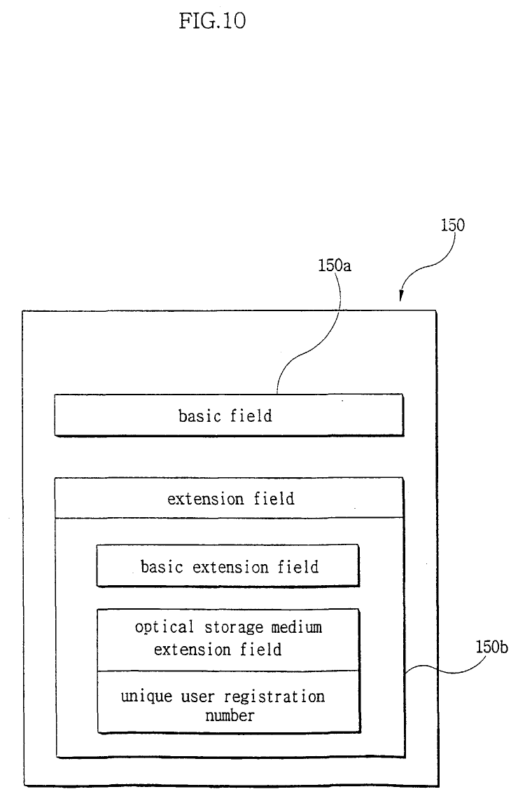

FIG. 10 is a view illustrating the format of the user certificate stored in the optical storage medium 150 in accordance with the present invention.

The user certificate is provided with a basic field 150a and extension field 150b on the basis of a certificate standard X.509. Stored in the basic field 150a of the user certificate are general information written on the optical storage medium 150, such as a user's name, serial number, expiry date, issuer's name, E-mail address, etc.

Stored in the extension field 150b of the user certificate is a unique user registration number for access to user information stored in the user information database server.

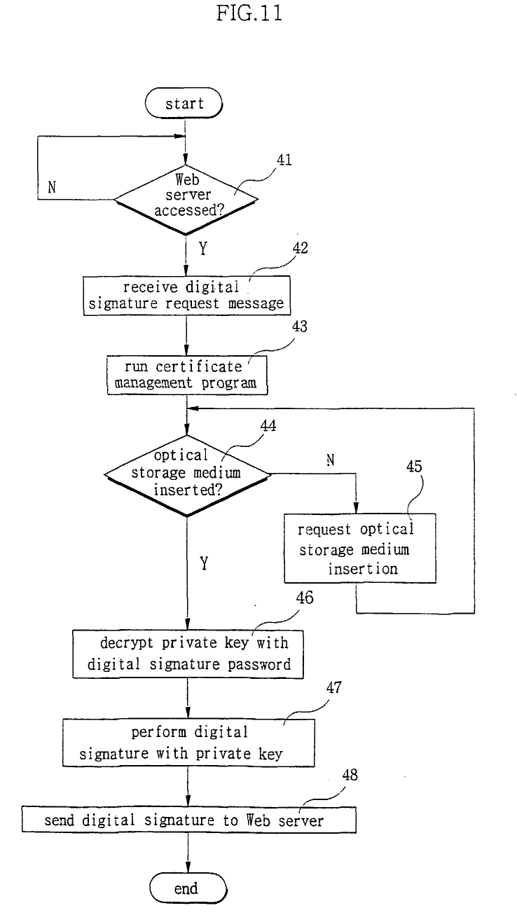

FIG. 11 is a flowchart illustrating a method for using the optical storage medium having the public key infrastructure-based private key and digital certificate stored therein in accordance with the first embodiment of the present invention.

First, if the user gains access to a Web server requiring a user certification, using a computer equipped with an optical storage medium reader (step 41), then he or she receives a digital signature request message from the Web server (step 42).

Then, the user runs in the user computer a certificate management program for performing a digital signature function based on the user certificate and private key, and user certificate/private key management, discard and reissuance application functions (step 43). The user computer determines whether the optical storage medium 150 has been inserted into the optical storage medium reader (step 44), and requests the user to insert the optical storage medium 150 into the optical storage medium reader if it is determined not to have been inserted into the reader (step 45).

If the optical storage medium 150 has been inserted into the optical storage medium reader, then the user computer decrypts the user private key encrypted and stored in the optical storage medium 150 with the digital signature password from the user (step 46) and performs a digital signature with the decrypted private key (step 47). Subsequently, the user computer sends the digital signature to the Web server, which in turn verifies it (step 48).

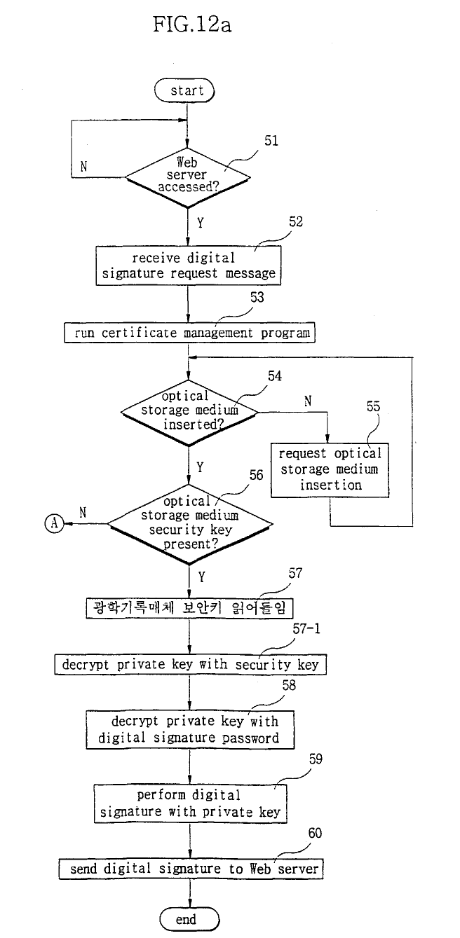

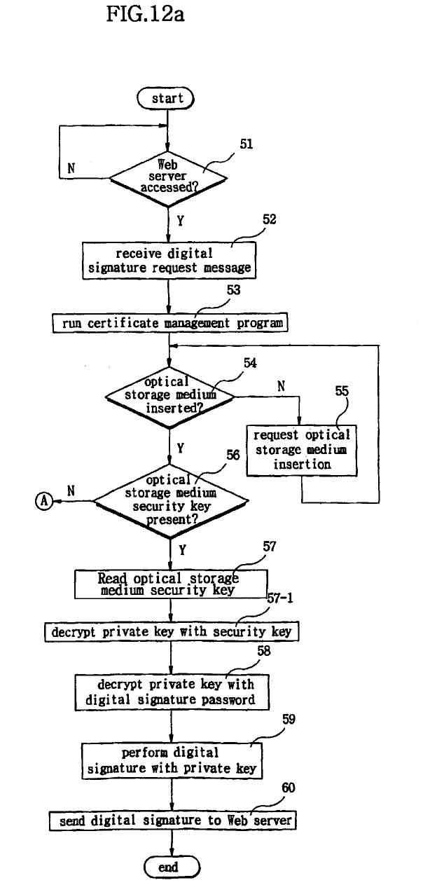

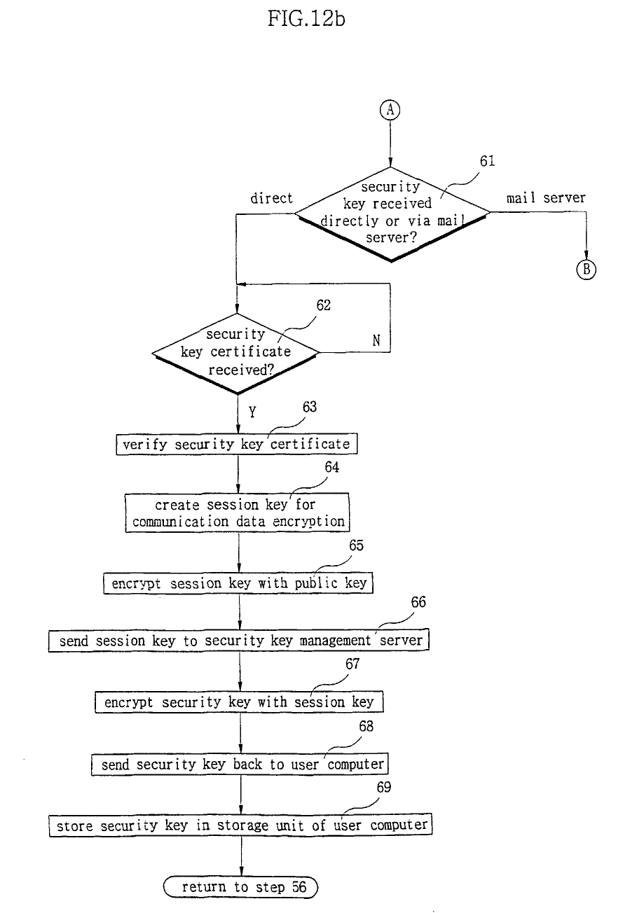

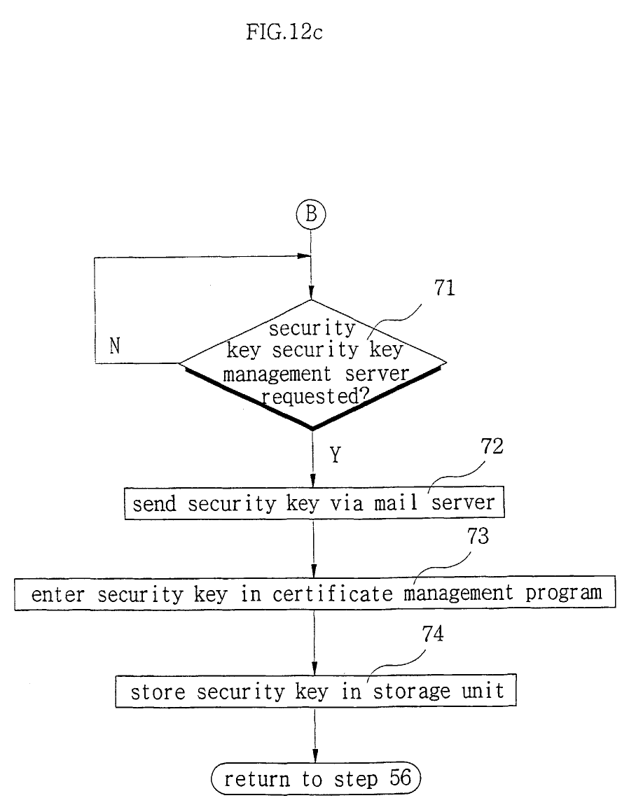

FIGS. 12a to 12c are flowcharts illustrating a method for using the optical storage medium having the public key infrastructure-based private key and digital certificate stored therein, using the security key management server, in accordance with the second embodiment of the present invention.

First, if the user gains access to a Web server requiring a user certification, using a computer equipped with an optical storage medium reader (step 51), then he or she receives a digital signature request message from the Web server (step 52).

Then, the user runs in the user computer a certificate management program for performing a digital signature function based on the user certificate and private key, and user certificate/private key management, discard and reissuance application functions, and communicating with the security key management server 130 storing and managing the optical storage medium security key, to download the security key from the server 130, store it in a storage unit of the user computer and use it (step 53). The user computer determines whether the optical storage medium 150 has been inserted into the optical storage medium reader (step 54), and requests the user to insert the optical storage medium 150 into the optical storage medium reader if it is determined not to have been inserted into the reader (step 55).

If the optical storage medium 150 has been inserted into the optical storage medium reader, then the user computer determines whether the optical storage medium security key is present in the storage unit (step 56), and reads the security key from the storage unit if it is determined to be present in the storage unit (step 57).

Thereafter, the user computer decrypts the user private key encrypted and stored in the optical storage medium 150 with the read security key and the digital signature password from the user (step 57-1 and step 58), performs a digital signature with the decrypted private key (step 59) and then sends the digital signature to the Web server (step 60).

On the other hand, in the case where it is determined at the above step 56 that the optical storage medium security key is not present in the storage unit, the user computer determines whether it will receive the security key from the security key management server 130 directly or via a mail server (step 61).

For the direct reception of the optical storage medium security key from the security key management server 130, if the user computer receives a security key certificate from the management server 130 (step 62), then it verifies the received security key certificate according to the certificate management program (step 63).

According to the certificate management program, the user computer creates a session key for communication data encryption (step 64), encrypts unique security key request information from the user and the created session key with a public key contained in the security key certificate from the security key management server 130 (step 65) and then sends the encrypted security key request information and session key to the management server 130 (step 66).

The security key management server 130 encrypts the security key with the session key sent from the user computer (step 67) and sends the resulting security key back to the computer (step 68). According to the certificate management program, the user computer stores the security key sent from the security key management server 130 in its storage unit (step 69).

For the reception of the optical storage medium security key from the security key management server 130 via the mail server, an electronic mail (E-mail) of the user is employed. In this case, according to the certificate management program, the user computer requests the security key management server 130 to send the security key to an E-mail address stored in the basic field of the user certificate (step 71). In response to the security key sending request from the user computer, the security key management server 130 sends the security key to the user's E-mail address via the mail server (step 72).

If the user enters the security key contained in his or her E-mail in the certificate management program (step 73), then the user computer stores the entered security key in its storage unit according to the certificate management program (step 74).

The user's E-mail may preferably employ a security mail system such as a PGP, S/MIME, etc.

If environments for execution of the certificate management program have not been set up in the user computer before the above step 53 of running the program in the user computer, the user runs an installation program in the computer to set up the program execution environments in the computer.

After the above step 60 of sending the digital signature to the Web server, if the Web server accesses the user information database server and requests it to transfer user information on the basis of a unique user registration number, then the database server transfers the user information to the Web server.

Alternatively, after the above step 59 of performing the digital signature, the Web server may request the user information database server to transfer the user information on the basis of a serial number contained in the basic field of the user certificate.

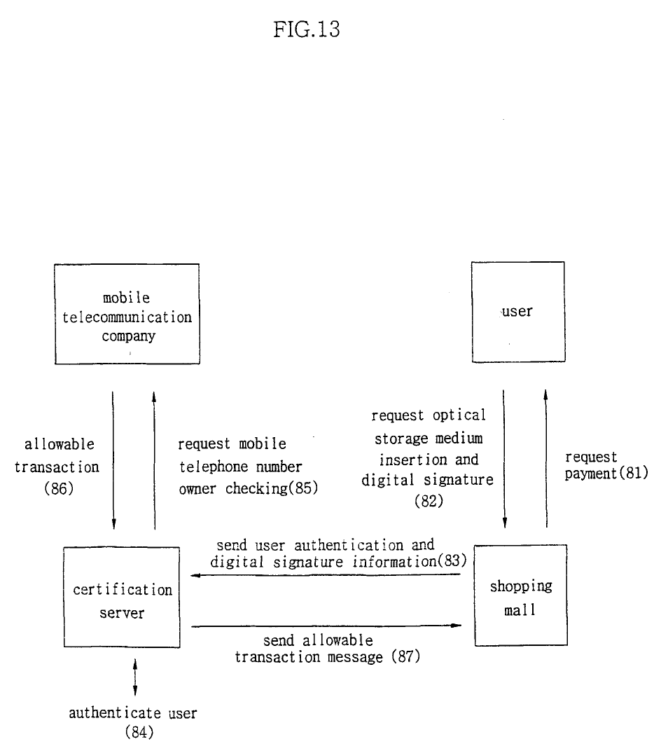

FIG. 13 is a drawing illustrating a procedure of payment through a mobile telecommunication company by a user in a shopping mall using the optical storage medium having the public key infrastructure-based private key and digital certificate stored therein in accordance with the present invention.

If the user owning the optical storage medium having the public key infrastructure-based private key and digital certificate stored therein purchases a commodity or service from the shopping mall, then the shopping mall requests the user to select a desired payment system and pay a predetermined amount ot money (step 81). Where the user desires to pay the money by means of a card or giro, the shopping mall allows the user to conduct the payment through a typical banking system. In case the user selects a payment system based on a mobile telecommunication company, the shopping mall requests the user to insert into a user computer the optical storage medium having the public key infrastructure-based private key and digital certificate stored therein and perform a digital signature according to the above-described method for using the optical storage medium (step 82).

If the user performs the digital signature with the user certificate and private key stored in the optical storage medium, then the user computer sends information regarding the user authentication and digital signature to the shopping mall, which in turn transfers the sent information to the certification server (step 83). As a result, the certification server authenticates the digital certificate and determines from the digital signature whether the user is a valid one (step 84).

After performing the digital signature-based certification procedure, the certification server requests the mobile telecommunication company to check whether a mobile telephone number presented by the user is the user's one (step 85). Where the presented mobile telephone number is the user's one, the certification server determines that the transaction by the user is allowable (step 86), and then sends a message indicative of the allowable transaction to the shopping mall (step 87). Accordingly, the user can settle his or her account for the purchasing price with the shopping mall.

### Industrial Applicability

As apparent from the above description, the present invention provides an optical storage medium for storing a PKI-based private key and digital certificate, a method and system for issuing the same and a method for using such, wherein a registration authority performs all separate procedures, such as certificate application, key pair creation, optical storage medium issuance, etc., and all complex procedures, such as associated software installation, etc., on behalf of a user. The registration authority also stores desired information in an optical storage medium, such as a CD, and provides the storage medium to the user.

Therefore, through only simple procedures, the user can conveniently apply to a certification authority for a certificate, be issued with the certificate from the certification authority and use the issued certificate.

Further, according to the present invention, a certification service can be provided in any computer equipped with an optical storage medium reader, such as a standard CD-ROM drive or DVD drive with a very high spread rate, thereby providing portability and extendibility of a certificate. This optical storage medium reader can further provide economy and standardization differently from an IC card or smart card reader which is not standardized and is low in spread rate due to its high price.

Further, according to the present invention, the registration authority is interoperable with a user information database to store a certificate in an optical storage medium and issue it to the user. This enables the efficient management of user information.

Further, according to this invention, the user can always carry an optical storage medium as a certificate storage medium, thereby increasing security compared to a fixed storage medium such as a hard disk. Moreover, the registration authority provides security for access to the optical storage medium at the time when it stores the private key and certificate in the storage medium and issues them to the user. This security is so high as to obviate risks such as a medium loss, duplication and so forth.

Furthermore, according to this invention, the large-capacity data storage capability and design, for example, a label, of the optical storage medium can be utilized to efficiently inform the user of public relation contents of each service provider and provide a service type identification function to the user.

These features of the present invention are novel proposals for the improvement in a conventional low spread rate and use rate of a user certificate that is essential to the electronic commerce and electronic business processes. Provided that the spread of an optical storage medium, such as a CD or DVD, having a private key and certificate stored therein is activated, public key infrastructure-based certification, integrity, confidentiality and repudiation prevention will be able to be certainly ensured on the basis of interoperability and security with the user information database in providing electronic commerce and financial payment services (electronic payment system: electronic fund transfer (EFT), E-credit card, E-cash, etc.), medical administration services (medical care insurance, reservation, medical prescription issuance, medicine reception, etc.), civil affairs administration services (local tax payment, residence certificate and census registration abstract issuance, marriage registration, birth registration, car registration and license application, etc.), and so forth. Furthermore, the present invention will greatly improve the efficiency and convenience of a variety of public key infrastructure-based services in the entire society, including adult site access, staff administration in enterprises or public institutions, safe electronic commercial commerce utilizing mobile telephones as payment means in shopping malls, and so forth.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. An optical storage medium adapted to store:
a public key infrastructure (PKI)-based user certificate, said user certificate being issued from a certification authority and including a public key for verification of a digital signature;
at least one certification authority certificate including a public key for verification of said user certificate; and
a user private key for the digital signature, encrypted with a digital signature password memorized by a user on the basis of a password-based encryption standard (PKCS#5).

2. The optical storage medium as set forth in claim 1, wherein said private key is stored in said medium after being encrypted once more with a password key, said password key being an optical storage medium security key stored and managed in a security key management server.

3. The optical storage medium as set forth in claim 1, wherein each of said certification authority certificate, user certificate and user private key stored in said medium is one or more in number.

4. The optical storage medium as set forth in claim 1, further adapted to store:
a certificate management program for performing a digital signature function based on said user certificate and private key, and user certificate/private key management, discard and reissuance application functions;
an installation program for setting up environments for execution of said certificate management program in a computer of said user;
an automatic access program for gaining automatic access to a specific Web server such that said user certificate is used in electronic commerce or electronic business processes;
a Web/mail plug-in program;
PKI-based application programs, said application programs including an electronic purse program; and
human body recognition information and public relation contents, said human body recognition information including fingerprints and retina map.

5. The optical storage medium as set forth in claim 1, wherein a magnetic strip, radio frequency chip or integrated circuit chip is attached to said medium so that said medium is applicable offline to a credit card, debit card, prepaid card, membership card and bus card as well as online to a digital signature-based certification.

6. A method for issuing an optical storage medium having a PKI-based private key and digital certificate stored therein, using a user information database server for storing user information, a certification authority server for creating a PKI-based user certificate by attaching a digital signature to the user certificate using its private key, and a registration authority computer for issuing said optical storage medium by communicating with said user information database server and certification authority server over a computer communication network, said method comprising the steps of:
a), by said registration authority computer, checking a user's identity in response to a digital certificate issuance request from the user, authenticating the user in accordance with the checked result, inputting user information entered by said user, transferring the inputted user information to said user information database server and registering it therein;
b), by said registration authority computer, forming a temporary storage area related to said user in its storage unit;
c), by said registration authority computer, creating a PKI-based public key and private key pair;
d), by said registration authority computer, encrypting the created private key with a digital signature password memorized by said user on the basis of a password-based encryption standard (PKCS#5) and storing the encrypted private key in said temporary storage area;
e), by said registration authority computer, producing a digital certificate request message containing the created public key and transferring the produced message to said certification authority server;
f), by said registration authority computer, receiving a user certificate issued from said certification authority server and storing the received certificate in said temporary storage area;
g), by said registration authority computer, reading the user certificate and private key stored in said temporary storage area and at least one certification authority certificate prestored in said storage unit and writing the read user certificate, private key and certification authority certificate on said optical storage medium; and
h), by said registration authority computer, erasing said temporary storage area in said storage unit.

7. The method as set forth in claim 6, wherein said steps c) and d) include the step of, by said registration authority computer, performing only the certificate issuance function without directly creating the public key and private key pair, and then sending a registration associated picture and password entry picture respectively to said user such that said user personally creates the key pair and enters the digital signature password.

8. The method as set forth in claim 6, wherein said method further comprises the step of:
i), by said registration authority computer, receiving a unique user registration number produced from said user information database server after registering said user information in said user information database server at said step a); and
wherein said step e) includes the step of, by said registration authority computer, producing said digital certificate request message and appending the received unique user registration number to the produced certificate request message.

9. The method as set forth in claim 6, further comprising the step of:
i), by said registration authority computer, registering a serial number of said user certificate in said user information database server after receiving said user certificate from said certification authority server at said step f).

10. The method as set forth in claim 6, wherein said step d) includes the step of, by said registration authority computer, encrypting said private key encrypted with said digital signature password, once more with an optical storage medium security key before storing it in said temporary storage area, transferring the optical storage medium security key to a security key management server to store it therein, and then storing the once more encrypted private key in said temporary storage area, said optical storage medium security key being a password key, said security key management server managing said security key for access to said user private key stored in said optical storage medium.

11. The method as set forth in claim 6, further comprising the step of:
i), by an optical storage medium label output unit, outputting a label to be attached to said optical storage medium, after said registration authority computer writes said user certificate, private key and certification authority certificate on said optical storage medium at said step g), said label containing the user's name, unique number, barcode and colorPIMS.

12. The method as set forth in claim 6, wherein said step g) includes the step of, by said registration authority computer, further storing on said optical storage medium:
a certificate management program for performing a digital signature function based on said user certificate and private key, and user certificate/private key management, discard and reissuance application functions;
an installation program for setting up environments for execution of said certificate management program in a computer of said user;
an automatic access program for gaining automatic access to a specific Web server such that said user certificate is used in electronic commerce or electronic business processes;
a Web/mail plug-in program;
PKI-based application programs, said application programs including an electronic purse program; and
human body recognition information and public relation contents, said human body recognition information including fingerprints and retina map.

13. A system for issuing an optical storage medium having a PKI-based private key and digital certificate stored therein, using a user information database server for storing user information, a certification authority server for creating a PKI-based user certificate by attaching a digital signature to the user certificate using its private key, and a computer communication network, said system comprising:
storage means for storing a program for control of processing means and information regarding the entire system operation;
said processing means connected to said storage means for operating according to the control program stored therein; and
optical storage medium writing means connected to said storage means and processing means;
said processing means being interoperable with said control program to input said user information, register it in said user information database server, form a temporary storage area related to a user in said storage means, create a public key and private key pair for production of a PKI-based digital certificate request message, encrypt the created private key with a digital signature password memorized by the user on the basis of a password-based encryption standard, store the encrypted private key in said temporary storage area, produce the digital certificate request message containing the created public key, transfer the produced message to said certification authority server, receive a user certificate issued from said certification authority server, store the received certificate in said temporary storage area, read the user certificate and private key stored in said temporary storage area and a certification authority certificate prestored in said storage means, write the read user certificate, private key and certification authority certificate on said optical storage medium and then erase said temporary storage area in said storage means.

14. A method for using an optical storage medium having a PKI-based private key and digital certificate stored therein, comprising the steps of:
a) gaining access to a Web server requiring a user certification and security, using a computer equipped with an optical storage medium reader;
b) receiving a digital signature request message from said Web server;
c) running in said computer a certificate management program for performing a user certificate/private key-based digital signature function, and user certificate/private key management, discard and reissuance application functions;
d) inserting said optical storage medium into said optical storage medium reader if said medium has not been yet inserted into said reader;
e) decrypting a user private key encrypted and stored in said optical storage medium with a digital signature password from a user;
f) performing a digital signature with the decrypted private key; and
g) sending the digital signature to said Web server.

15. A method for using an optical storage medium having a PKI-based private key and digital certificate stored therein, comprising the steps of:
a) gaining access to a Web server requiring a user certification and security, using a computer equipped with an optical storage medium reader;
b) receiving a digital signature request message from said Web server;
c) running in said computer a certificate management program for performing a user certificate/private key-based digital signature function, and user certificate/private key management, discard and reissuance application functions, and communicating with a security key management server to download an optical storage medium security key from said management server, store it in a storage unit of said computer and use it, said management server storing and managing said optical storage medium security key;
d) determining whether said optical storage medium has been inserted into said optical storage medium reader, and inserting said optical storage medium into said optical storage medium reader if it is determined not to have been inserted into said reader;
e) determining whether said optical storage medium security key is present in said storage unit, and reading said security key from said storage unit if it is determined to be present in said storage unit;
f) decrypting a user private key encrypted and stored in said optical storage medium with the read security key;
g) performing a digital signature with a digital signature password from a user and sending the digital signature to said Web server;
h) receiving a security key certificate from said security key management server if it is determined at said step e) that said optical storage medium security key is not present in said storage unit;
i) verifying the received security key certificate according to said certificate management program;
j), according to said certificate management program, creating a session key for communication data encryption, encrypting unique security key request information from said user and the created session key with a public key contained in said security key certificate from said security key management server and then sending the encrypted security key request information and session key to said management server; and
k) allowing said security key management server to encrypt said security key with said session key and send the resulting security key back to said computer, and storing said security key sent from said management server in said storage unit according to said certificate management program.

16. The method as set forth in claim 15, further comprising the steps of:
l) requesting said security key management server to send said security key to an E-mail address stored in a basic field of said user certificate, according to said certificate management program if it is determined at said step e) that said security key is not present in said storage unit;
m) allowing said security key management server to send said security key to the user's E-mail address via a mail server in response to the security key sending request;
n) allowing said user to enter said security key contained in his or her E-mail in said certificate management program; and
o) storing the entered security key in said storage unit according to said certificate management program.

17. The method as set forth in claim 14 or claim 15, wherein said user certificate includes an extension field based on a certificate standard (X.509), said extension field including an optical storage medium extension field for storing a unique user registration number for access to user information stored in a user information database server, and wherein said method further comprises the steps of:
allowing said Web server to access said user information database server after said digital signature is performed, and request said database server to transfer said user information on the basis of said unique user registration number; and
allowing said user information database server to transfer said user information to said Web server.

18. The method as set forth in claim 14 or claim 15, wherein said user certificate includes a basic field for storing a serial number, and wherein said method further comprises the step of allowing said Web server to request a user information database server to transfer user information stored therein on the basis of said serial number.

19. The method as set forth in claim 14 or claim 15, further comprising the steps of:
allowing a shopping mall to request said user owning said optical storage medium having the PKI-based private key and digital certificate stored therein to insert said storage medium into said computer and perform said digital signature with said storage medium, if he or she selects a payment system based on a mobile telecommunication company to purchase a commodity or service from said shopping mall;
allowing said shopping mall to receive information about said user certificate and private key from said computer and transfer the received information and information about said digital signature to a certification server such that said certification server authenticates said digital certificate and determines from said digital signature whether said user is a valid one; and
allowing said certification server to request the mobile telecommunication company to check whether a mobile telephone number presented by said user is the user's one, to determine that the transaction by said user is allowable if the presented mobile telephone number is the user's one, and then to send a message indicative of the allowable transaction to said shopping mall, thereby enabling said user to settle his or her account for the purchasing price with said shopping mall.
